(19) United States
(12) Patent Application Publication
(10) Pub. No.: US 2018/0207835 A1
(43) Pub. Date: Jul. 26, 2018

(54) SELF-TREATMENT OF UTILITY POLES IN USE

(71) Applicants: Libere NITUNGA, Bujumbura (BI); WOOD-PERFECT CORPORATION, Tennessee, TN (US)

(72) Inventor: Libere NITUNGA, BU (BI)

(21) Appl. No.: 15/758,359

(22) PCT Filed: Sep. 9, 2016
(86) PCT No.: PCT/IB2016/055403

§ 371 Date: Mar. 8, 2018

(30) Foreign Application Priority Data
Sep. 10, 2015 (BI) 328/BI
Sep. 8, 2016 (BI) 335/BI

(51) Int. Cl. B27K 3/10; B27K 3/02; E04H 12/22; B27K 3/14

(52) U.S. Cl. CPC B27K 3/105; B27K 3/0235; B27K 3/0257; B27K 3/14; E04H 12/2292

(57) ABSTRACT

A method for treating a ground-line area of wooden posts in use, that consists of burying a tank of treatment product in the ground next to the post, with a mechanism that automatically injects a certain quantity of said treatment product into the post, once per year. The driving agent allowing said injection can be a pressure generated within the device itself by various means, or electric current originating from a photovoltaic panel or a battery. The technique is non-invasive for the post, and offers the opportunity to choose a tank of required size, and the quantity of treatment product to be automatically injected into the post once per year. The technique is of particular interest for posts installed in built-up areas, because most existing techniques require the pavement to be broken so that the base of the post be exposed to be treated, and then rebuilt after treatment.

### TECHNICAL FIELD

This invention is regarding ground line area protection of in use wood poles.

International Patent Classification (IPC): B27K 3/02

### BACKGROUND ART

The failure of power and telephone poles occurs at the ground line area in more than 90% of cases. The ground line area is the area of the pole that is at the same time in contact with the earth and with the air=: up to about 20 cm below and above ground level. This is the area where the development conditions of rot and fungi are most common and favorable because of plenty of oxygen and moisture. Below 20 cm, there is moisture but not enough oxygen; and above 20 cm there is oxygen but generally no sufficient moisture.

This area represents less than 5% of the total length of the pole, but it gets a lot of attention from the researchers. For more than a century, we have not stopped from trying new techniques to solve this problem.

The number of patent documents relating to the matter gives an idea of the place occupied by the ground line protection within the concerns of professionals in the sectors.

The treatment of wood poles in use usually consists of making the treating chemical to penetrate in the wood mass by diffusion, starting from what could be called a “tank”. This tank may be external or internal to the pole.

The external tank takes the form of a bandage foam impregnated with antiseptic product, which is wrapped around the pole at the ground line area.

Due to the moisture of the wood, the antiseptic chemical contained in the bandage moves seeps gradually into the pole and protects it against termites and rot fungi.

For the treatment by bandages, see especially the patent documents GB 833818 and U.S. Pat. No. 5,591,263. Moreover, in the International Patent Classification, the entire class B27 K 3/14 is dedicated to bandages impregnation methods.

The following patent documents also show other kinds of external tanks for treatment of wooden poles in use: GB2327225, U.S. Pat. No. 4,817,346, U.S. Pat. No. 1,735,722, U.S. Pat. No. 1,419,108, and U.S. Pat. No. 3,834,329.

Regarding the use of an internal tank, it takes several forms: injection of antiseptic chemical by syringes, a longitudinal tank drilled in the axis of the pole, or oblique tank drilled from the outside of the pole.

The following patent documents illustrate the use of a longitudinal tank drilled from bottom end of the pole: WO2006/026854 (FIG. 1), CH415016 (FIG. 1-5), and U.S. Pat. No. 5,925,368 (FIGS. 5 and 6).

After of the pole is erected, the only tank that can be drilled is the oblique one, as shown in documents FR2606060 (FIGS. 4a and 4b), CH415016 (FIG. 6), U.S. Pat. No. 5,925,368 (FIG. 2 to 4), WO03/035342 (Page 8 lines 4-6).

However, the most common technique currently being used to protect the ground line area of poles in service is the so-called Cobra method, which consists of removing the foundation of the poles on about 500 mm deep, injecting the treatment product in the form of a paste into incisions of about 7 cm made with flat and hollow syringes, covering the area treated with a bituminous material, and finally putting on top of this material a waterproof coating.

### SUMMARY OF THE INVENTION

A method for treatment of a ground line area of a wooden pole in contact with the ground is provided. The method comprising: forming an oblique or longitudinal cavity in the wooden pole: hosting a watertight tank into or around the oblique or longitudinal cavity, wherein the watertight tank comprises a treatment product, the watertight tank having a supply or transfer pipe extending from a bottom portion of the watertight tank: and routing the treatment product from the watertight tank via the supply or transfer pipe to come into contact with the wooden pole only along the ground line area, after having traveled through the supply or transfer pipe.

In one embodiment, in the oblique cavity, hosting the watertight tank of the treatment product comprises hosting the watertight tank partially in the wooden pole and partially in soil surrounding the wooden pole. In another embodiment, hosting the watertight tank, in the oblique cavity, comprises drilling the watertight tank of the treatment product directly and completely into soil surrounding the wooden pole, without any part of the watertight tank being in the wooden pole to host the watertight tank in a vicinity of the wooden pole.

In one embodiment, the method further comprises forming, along the ground line area, small diameter holes to constitute a distribution network for the treatment product to be distributed. The distribution network comprises an absorbent material.

In one embodiment, the method includes routing the treatment product comprises overcoming gravity to ascend the treatment product to the around line area, by means of electric pumping, of the pressure created by the weight of a body placed on the treatment product under liquid form, a gas under pressure, a mechanical spring, a capillary rise, or the combination thereof.

In one embodiment, the method further comprises regulating a period and a output quantity of the treatment product and/or a return of air by one or more device involving a use of valves adapted to be controlled at least electrically, thermally or lightly.

In one embodiment, the method further comprising: routing the treatment product partially or totally by using of a capillarity of an absorbent body placed along a path of the treatment product to the around line area, wherein performance of the capillarity combines an action of a highly absorbent flexible absorbent material, with a rigid body, to constitute a sort of rigid ladder for the treatment product to be transported to the ground line area.

In one embodiment, the method further comprising: installing the watertight tank having the treatment product at a top of the wooden pole to benefit from the action of gravity in conveying the treatment product to at the ground line area or other point of application at the pole.

In one embodiment, the method further comprising: pushing the treatment product into the supply or transfer pipe via a piston and a blocking rod integral with the piston, wherein the rod comprises locking clamps that enables a variation in a length of the rod with the variation of temperature, such that the rod is locked against locking clamps above a certain temperature, and the rod is released from the locking clamps below a certain temperature, thereby allowing the continuation of the pumping from the treatment product to the wooden pole, when an outlet valve of supply or transfer pipe carrying the treatment product is open.

In an example embodiment, the locking clamps of the piston or a part thereof are retractable.

In one embodiment, the rod and/or the locking clamps comprises of a hollow body filled with gas to expand and shrink as a function of temperature, possibly using a slight depression to result in intense evaporation, or via boiling, likely to cause sufficient elongation of the rod.

In one embodiment, the method further comprising: one or more constructive arrangements firstly to enable the watertight tank to be refilled with the treatment product without the blocking clamps blocking the rod, and secondly to prevent the rod blocking is not blocked by the clamps when, after retracting due to the decrease of the temperature, rod expands again with the increase of the temperature. The one or more of the constructive arrangements comprises: a semi-rigid articulation of the locking rod allowing the rod to configure a V-shape; a flexible locking rod to bend slightly in the opposite direction to the pumping force: a bar and a flexible or articulated blade placed at an end of the bars; and tapered end design of bar and rod to orient the blocking rod in a desired direction.

### BRIEF DESCRIPTION OF THE DRAWINGS OF THE INVENTION

Prior Art Drawings:

FIG. 1 illustrates a sectional view of a pole with a longitudinal tank in the pole axis, full of treatment product, according to the conventional technique;

FIG. 2 illustrates a sectional view of the same pole, but with the tank half empty, according to the conventional technique; and

FIG. 3 illustrates a sectional view of the same pole, but with the tank almost empty, according to the conventional technique.

### Present Invention Drawings:

FIG. 4 illustrates a sectional view of a pole with a longitudinal tank in the pole axis, with the tank still full of treatment product, according to an embodiment of the present invention:

FIG. 5 illustrates a sectional view of a pole with a longitudinal tank in the axis of the pole, but with the treatment product in the half-consumed tank, according to an embodiment of the present invention:

FIG. 6 illustrates a sectional view of a pole with a longitudinal tank in the axis of the pole, but with the treatment product in the tank almost completely consumed, according to an embodiment of the present invention;

FIG. 7 illustrates a sectional view of a pole with an oblique tank, according to an embodiment of the present invention;

FIG. 8 illustrates a sectional view of a pole with an oblique tank, which extends beyond the limits of the pole and enters the surrounding ground, according to an embodiment of the present invention;

FIG. 9 illustrates a sectional view of a pole and a tank completely independent of the pole, according to an embodiment of the present invention:

FIG. 10 illustrates a sectional view of a tank where the treatment product rises to the point of application by pressure, according to an embodiment of the present invention;

FIG. 11 illustrates a sectional view of the relative position of the tank and the pole, in the case of using compressed air to pump the treatment product into the pole, placed below the treatment product, according to an embodiment of the present invention;

FIG. 12 illustrates a sectional side view of the rod and locking clamps, according to an embodiment of the present invention:

FIG. 13 illustrates a sectional view of the rod and locking clamps, according to an embodiment of the present invention;

FIG. 14 illustrates a top view of the locking pin and grooves for the locking clamps, according to an embodiment of the present invention;

FIG. 15a illustrates the rod rising towards the locking clamps, when the outlet valve of the treatment product is open, according to an embodiment of the present invention;

FIG. 15b illustrates the wedge locked by the clamps, and the orientation blade pushed in horizontal position, according to an embodiment of the present invention:

FIG. 15c illustrates the locking rod in the same position as before but in a retracted position at the lower temperature, the orientation blade released and returned to their original position, according to an embodiment of the present invention: and

FIG. 15d illustrates the locking rod in the same position as before, but expanding due to temperature rise, and moving over the bars, according to an embodiment of the present invention.

### DESCRIPTION OF THE INVENTION

Currently the two most commonly used treatment methods for ground line area are antiseptic bandages and said Cobra injections both of which make the treatment product penetrate from the outside surface of the pole. In both the cases, when the treatment chemical is exhausted, the treatment is renewed, by the wrapping of a new bandage or the execution of new injections. This invention consists, in turn, in an improvement of the ground line area treatment techniques with a product being (placed) in an axial or oblique tank.

The finding that is the basis of this invention is that with the techniques in question, the treatment product introduced into the longitudinal or oblique cavities begins to diffuse into the pole through the entire contact surface with the latter. There is therefore a quantity of product that will be absorbed below 20 cm from the ground level while this area is not exposed to rot as shown above. It is therefore a waste that this invention gets suppressed by storing the treatment product in a sealed tank.

The second disadvantage of these techniques is that after a certain period of operation, when the tank is no longer full, the ground line area is no longer supplied with chemical. This invention settles this issue by routing to the ground-line area, even the last drops of chemical being at the bottom of the tank using a pipe or a sealed conduit.

The first main feature of the invention is therefore the use of a watertight tank and the routing of the treatment product to the ground line area, using a transfer pipe or watertight supply line. As a result, the treatment product will diffuse by ground line area and only at the ground line area; be the tank is full, half full or almost empty.

The second main characteristic of the invention results from this feed of the ground line area with treatment product via a point but not via a contact area, then requiring the realization of a distribution network of the said product in the ground line area.

According to the invention, the said distribution network consists of a network of small diameter galleries, made of blind holes drilled from the outside, whose orifices are then plugged to prevent contact with the outside. The gallery may advantageously be filled with absorbent material such as sawdust, to achieve a more homogeneous distribution of the product.

The galleries of the distribution network do not need to be in direct contact. The chemical can pass through the thin layer of wood that could separate them.

By seeking to increase the capacity of the tank of the treatment product to gain an even greater advantage from the previous achievement, we realized that the insulation of the treatment product so that it does not come into contact with the wood except at the point of application, allows the cavity to be drilled beyond the pole, into the surrounding soil and as far as desired, since there is no longer a risk of chemical leakage into the ground, with the use of watertight tank and supply pipe.

Subsequently we realized that, since we can use a partially drilled tank in the pole and partially in the surrounding soil, nothing prevents to dig directly and integrally the tank in the surrounding soil, without any part of the tank into the pole. This brings us to the third main feature of the invention which is the location of the tank in the ground in the vicinity of the pole in use. There are many advantages, including a free choice of the shape and capacity of the tank, a great ease of replenishment of the tank in treatment product, intervention on the device for control, repair, replacement, etc.

The fourth main characteristic of the invention is therefore the possibility of regulating the supply of the ground line area treatment product by a localized physical device such as a valve, given the localized but not diffuse way of the treatment product from the tank to the ground line area.

The main challenge that remains to achieve these objects of the invention is to overcome the gravity that acts on the treatment product and prevents it from mounting from the tank to the ground line area.

We describe below two examples of mechanisms that can overcome gravity and bring the treatment product from the tank to the ground line area.

The First Mechanism is to Put the Treatment Product Under Pressure.

Consider a treatment product in liquid or near-liquid form contained in a watertight underground tank, placed next to a pole in use. We here refer to treatment product in quasi-liquid form, a product which without being liquid in the usual sense of the term, has properties which make it possible to mount in the supply pipe described in this invention, as the liquid would do. The said tank has a cross section of any shape but preferably cylindrical, rectangular or square. In the following development, we take the example of a tank disposed vertically in the soil, the treatment product in the form of aqueous solution being subjected to the pressure of a piston kept at the upper part of the tank, and which has an exit at the bottom towards the supply pipe. To overcome the gravity, the inside of the tank is subjected to a pressure, which will push the liquid to rise in the supply pipe.

One of the means for producing this pressure is to adapt a piston inside the tank with appropriate seals to prevent leakage of the treatment product between the said piston and the tank cover. The force acting on the piston to create the pressure in the treatment product may be the weight of the piston alone or weighed down by an additional mass, a mechanical spring, a compressed gas such as air, etc. Each solution has its own advantages and disadvantages.

The seal between the piston and the outer cover of the tank can be advantageously replaced by the following device:

A watertight inner flexible cover, in the form of a plastic bag, for example, is placed inside the tank, and applied to its upper part against the piston. Said inner cover preferably has folds of the accordion type so that as the treatment product is exhausted, there is no risk of wrinkling of the inner cover. These wrinkles would lead to a risk of blockage of the piston during its downward movement as and when the product is depleted. The move down of the piston creates a depression on its upper face, depression which may oppose moving down of the piston, and therefore the outflow of the treatment product. To remedy this problem, this space is brought into contact with the atmospheric pressure by a so-called return pipe, directly or through a control valve. It should be noted that if the driving agent chosen to create the pressure in the tank is a compressed gas, the question of the return pipe does not arise, the question of sealing either because the gas can simply be contained in a sealed bag in contact with the treatment product.

There is no advantage in sending to the pole a quantity of treatment product greater than the minimum dose sufficient to ensure the protection of the pole, which is generally weak and is so-called efficiency threshold. We therefore often face the regulation of the rate at which the treatment product enters the pole, in the direction of its reduction, so that the stock of treatment product lasts for a longer duration.

One of the objects of this invention is to provide mechanisms for regulating the flow of the treatment product leaving the tank to enter the pole. First, there are self-moving solutions which depends on such as the choice of the piston weight, the section of the supply line, the installation of bottleneck line areas, and so on. In the context of this invention, we provide valves with thermal control, so seasonal or even daily regulation. These are basic devices, so extremely simple and reliable. Their operating principle is generally based on the dimensional variation of certain materials with temperature, which may allow closing or opening the passage beyond or below a certain temperature. This is all the more simple as the bit rate to pass or block is very low. Thus, depending on the region where one is, one can choose for example to allow or not to allow the return of air above the piston, to allow or not to allow the exit of the treatment product when the temperature passes above or below −20° C., −10° C., 0° C., 5° C., 7° C., 15° C., 25° C., etc. Given the room for handling available in terms of tank capacity, ease of renewal and other means of regulation, high accuracy at this level is not essential.

Light-controlled valves may also be used to open or close the passage only during the day or only during the night.

In addition, the passage of the treatment product of the supply pipe to the distribution circuit in the pole is through a kind of filter or absorbent material more or less dense that will ensure that the treatment liquid does not does not flow, but oozes very slightly like a small leak on a container.

If we take the example of a rate corresponding to a drop of product every 10 minutes, it is 6 drops per hour or 150 drops per day, the equivalent of about 6 ml per day. If the valve opens the passage during the hottest 3 months of the year, so for 90 days a year, it takes half a liter (0.51) of treatment product per year; that is 5 liters for 10 years.

The goal is that after a very comfortable renewal period of 10-15 years, or even 20 years, we are sure that the product will not be completely exhausted, or not for a long time. Without having to go as far as 10 years, poles undergo a periodic inspection every 3-5 years. At this point, the inspector can very easily refuel the tank in minutes, as is done with fuel for a car at the gas station.

For the valve not to be a handicap at the time of renewal, it is preferably placed at the entrance or just after the entry of the supply pipe into the pole. Before the valve, there is therefore an accessible terminal for renewal.

Another way of reducing the flow rate of the treatment product leaving the tank is to place such a valve on the return air duct. By blocking the return of air, it causes with some delay a vacuum in the space between the upper face of the piston and the tank. This depression has the effect of gradually slowing the flow out of the tank, until it stops completely. For example, by choosing for the air return valve which closes above −10° C. and for the outlet valve to the supply line opening above +25° C., we will have an intermittent functioning. Indeed, when the outlet valve will open, the depression above the piston will gradually slow the flow of the antiseptic solution until it stops completely, because at +25° C., the inlet valve of the air will be closed. The space above the piston will return to atmospheric pressure only during the cold season, when this valve will open at −10° C. At this time, the outlet valve to the supply line will be closed until the next hot season, and so on.

The possibilities of combining mechanisms for creating pressure—vacuum with the input—output control mechanisms are numerous.

Hereinafter, another execution of intermittent pumping is described which makes it possible to determine more precisely the quantity of product that it is desired to inject into the pole each year.

Take the example of an underground tank using air under pressure to push up the treatment product to the ground line area, the air under pressure being disposed below the piston, and the treatment product above it. When the ambient temperature reaches for example 25° C., then the outlet valve of the treatment product opens. The treatment product starts to get out of the tank, and the piston moves up inside the tank. In principle, it will do so until the valve closes when the ambient temperature falls below 25° C. But we can determine the stroke of the piston, and therefore the maximum amount of treatment product to be introduced into the pole. A device that is the subject of this invention includes by introducing locking clamps of the piston inside the tank, at a regular distance, or irregularly, depending on whether it is desired to inject more treatment product during the first years and a smaller quantity of them the following years. These clamps are installed in grooves made in the cover of the tank, so that they impede the movement of the piston. This requires that the air under pressure and the treatment product be in watertight covers so as not to spill into these grooves. A so-called locking rod, integral with the piston, has such a length that after expansion at 20° C. for example; it cannot pass between the locking clamps. But on the other hand after withdrawal at −10° C. for example, its length allows him this time to pass between the locking clamps.

Thus at this temperature, the piston will be unlocked and can push the treatment product into the pole. But at this temperature, the outlet valve, which opens at 25° C., is closed. So we just need the piston released at this temperature, so that when it is 25° C. again, it can go up to the next clamps, and so on the next year. To do this, it is possible to use a locking rod made of a material with a high coefficient of thermal expansion, such as polypropylene, rilsan, etc. The bars can also be made of a material with a high coefficient of thermal expansion, so that they also retract in time as the blocking rod, and thus also contribute to clear the latter.

Indeed, the linear thermal elongation of a body is in the form: δL=Lₒ·α·DT where δL is elongation; a is the coefficient of thermal expansion of the material, and ΔT is the temperature difference. It follows that the initial length is one of three factors of elongation and withdrawal, allowing the locking or unlocking of the piston. In the case mentioned above, the initial length consists of the length of the locking rod and the two locking clamps. To benefit from a greater coefficient of expansion, the rod and the locking clamps may consist of a hollow cover filled with gas but designed so as to be able to lengthen and retract with the variations of temperature. To do this, one can for example provide an elastic zone on the rod.

Better results are obtained using a material that has a boiling point between the opening temperature of the outlet valve of the treatment product and the minimum temperature that can be considered as guaranteed in the geographical area considered. One can take the example of pentane, whose boiling point is 36.06° C. By acting on the pressure inside the rod in the direction of its reduction, this boiling point may fall below 25° C. taken as an example of opening threshold of the outlet valve of the treatment product.

Even without boiling, this shows that at this temperature even at atmospheric pressure, the evaporation of this gas is so important that it can lead to sufficient elongation of the blocking rod. However, the use of less volatile materials such as regular gasoline, alcohol, etc. will require some reduction in pressure inside the blocking rod to achieve sufficient elongation at 25° C.

If no special provision is made, the blocking rod may operate at a place under the bars, when the temperature will vary from minimum to maximum. Indeed, at 25° C., the piston moves up until the locking rod abuts on the bars. When the temperature drops to −5° C., the rod will retract and disengage from under the bars. But as at this time the outlet valve of the treatment product is closed, there is no movement of liquid and the rod cannot move up if it constantly pushed by the pressurized air; it stays at the same height.

When the temperature rises again, the rod will expand and re-enter the bars without being able to advance when the outlet valve has opened at 25° C.

To remedy this situation, the ends of the clamps and the rod have a rounded profile. In addition there is provided on the bars a so-called orientation plate which, when the locking rod retracts below a certain temperature, passes below the said rod. In this way, when the temperature goes up and the blocking rod to expand, it will not go under the bars because the way it is blocked by the orientation plate. This one directs it, as its name suggests, above the clamp.

The role of the orientation plate can be played by the clamps themselves, if they are slightly articulated at the place where they are fixed at the bottom of the groove to be pendulous, that is to say slightly inclined towards down at their free end.

When the locking pin rises, it finds the bars in their lower position and rises with them to their upper position, where they stop together.

When the temperature goes down and the rod will retract to the release of the clamps, they fall back to their lower position and are therefore under the clamp. At the moment when the temperature will rise and the rod will expand, the clamps will be below the rod. In this way, when the outlet valve of the treatment product will open at 25° C., then the piston will rise to the following clamps.

It should be noted that the bars do not come out of the grooves so as not to impede the movement of the piston and the watertight covers containing the treatment product and the air under pressure.

Other constructive measures facilitate this work of locking/unlocking the piston. This involves using a thin blocking rod so that it can be positioned above the clamp without having to push too hard on the volume occupied by the treatment product. It is also to use a locking rod having a certain flexibility that allows it to bend slightly downwards and thus orient its ends above the bars. This also compresses the air below the plunger rather than compressing the liquid form of treatment product that is above the plunger. The rod may also be provided with a semi-articulation in the middle, which plays the same role of softening the locking rod as it expands so that it is oriented above the bars.

This important characteristic of the blocking rod is also useful at the time of refilling the tank with treatment product. Indeed, at the time when the tank is refilled with treatment product, the blocking rod may abut on the bars and thus prevent loading. The rod needs to be flexible and/or to have the semi-articulation not to be blocked by the bars in its downward movement.

In developed countries where the risk of vandalism of public installations is low, it is possible to use electric batteries or photovoltaic panels fixed on the pole for pumping the treatment product and/or to carry out the various valve opening commands, locking clamps, etc.

This leads to simplification and lightening of the facilities.

A Second Mechanism of Supply of the Around Line Area is the Capillary Rise.

We use the capillarity of certain materials. The capillary rise is a phenomenon usually encountered in the construction, by which the moisture of the soil raises in the walls as a result of the porosity of the building materials used. This phenomenon is used in the context of this invention to feed the ground line area of the poles with a treatment product located in an underground tank. To do this, we have an absorbent material in the supply pipe, which will act as the way the wick does in a kerosene lamp.

However, in order to have a suitable height and climbing speed for pole processing, we have improved the height and rate of ascension by capillarity as described hereinafter.

In a given situation, an absorbent material has a maximum height at which it can raise a liquid with which it is in contact. Indeed, the gravity acts permanently on the product and limits the height that it can reach. At a certain height the weight of the column of the liquid becomes too great for the rise to continue.

To improve this performance in the context of this invention, we plan multiple steps on the path of the rising liquid, in the same way that we do if we have to climb over a large embankment, we use a ladder with several steps. Without the ladder, there is a maximum height of slope that cannot be exceeded. It's the same thing as if someone wants to climb a tree with great asperities He climbs it easily because each big asperity is like walking a ladder. For the supply line we also make a device similar to a ladder. The absorbent material raises vertically, then “pauses” on a horizontal surface, or slightly inclined downward. It climbs one more step, then pauses again on a horizontal surface or slightly inclined down, etc. By taking this step, the liquid will reach a greater height than if it had not used the ladder. It is a question of breaking the continuity of the column of liquid on which gravity is exerted. If we take the example of a paper towel as an absorbent material, a step is made by wrapping it around a porous or spongy body having a sufficient rigidity, such as a wooden rod that has been crushed with kicks of a hammer. The objective is to give a physical support to the absorbent material, while achieving an interruption of the sections of water columns on which the gravity is exerted.

As a means of pushing the treatment product up to the ground line area, it is possible to combine the pressure and the capillary rise.

If one wants to go much higher than the ground line area and treat the fastening area of the cross arms near the top of the pole for example it is advantageous to put a tank at the head of the pole, so that the supply pipe is the shortest possible. Here it will no longer need pressure or capillary rise to push the treatment product in the supply pipe, since it will flow in the direction of gravity.

It should be noted that in the two methods of the invention mentioned above that are the pressure and capillary rise, it is possible to measure the amount of treatment product remaining in the underground tank, in the same way as it is done to measure the level of oil in the engine of a car, with the gauge.

For the regulation of the flow in regions with highly contrasted temperatures between seasons, it is possible to use a treatment product that freezes during the cold season, and therefore cannot move in the supply line, and thaws during the hot season, and therefore can evolve into the intake duct during the hot season.

In addition, particularly in the case of capillary rise, it may be advantageous to provide a tank which surrounds the base of the pole at ground level, or slightly above the ground, or slightly below the ground for reasons of aesthetics or other conveniences, but with all the elements already mentioned including the supply pipe, the point of penetration, the control valves, the return air hoses, etc. This gives a kind of rechargeable or self-refillable bandage.

This invention allows not only the easy installation of a tank of the high capacity processing product, but also an easy and quick replenishment.

This paves the way for the use of leachable treatment products, which are now reserved for wood treatments that is neither in contact with the ground nor exposed to the weather. These include borax and table salt. These are chemicals with a very low environmental impact, of which a possible excess in the protection of the ground line area of the poles would be without serious consequences to the cost of the treatment, or for the protection of the environment.

The technique which has the most similarities with this invention is disclosed in patent number U.S. Pat. No. 4,817,346 because it fulfills the conditions of watertight tank and integral use of the treatment product to the identified penetration zone, in principle. However: The given technique relates to the treatment of poles and fence poles, the reality and challenges of which are different from the ground line area treatment of the poles being used:

(i) The buried length of the post is of the order of 50 cm. By soaking the surface at the base of the post, it may be hoped to spread to the level of the ground line area, which is excluded in the case of utility poles. The area to be treated is at a distance of about 150-250 cm from the lower end of the pole.
(ii) So that this surface at the lower end of the post can receive the treatment product, the tank is disposed below the pole and the weight of the latter is fully supported by the said tank. It would be very difficult to bear the weight of public utility poles to such a tank, which is in the range of 250-1000 kg.
(iii) This technique can only be applied to poles being installed because the tank could not be installed under existing poles unless they are completely unearthed and reinstalled, which is not the case can be considered.

In GB2327225A, the entire underground part of the pole is immersed in a tank containing the treatment product.

In the document U.S. Pat. No. 3,834,329, there is shown a mobile machine for injecting a treatment product into the gap between the pole and the foundation soil.

Document U.S. Pat. No. 5,925,368 shows the great importance of controlling the diffusion of the chemical in the wood over time. Without such control, at first the wood receives too much treatment product, well beyond its needs, which leads to a rapid depletion of the reserve. Subsequently the wood no longer receives enough chemical for its protection. The multiple possibilities of regulating the consumption of the treatment product is one of the most important aspect of this invention, consecutively to its location through the supply pipe.

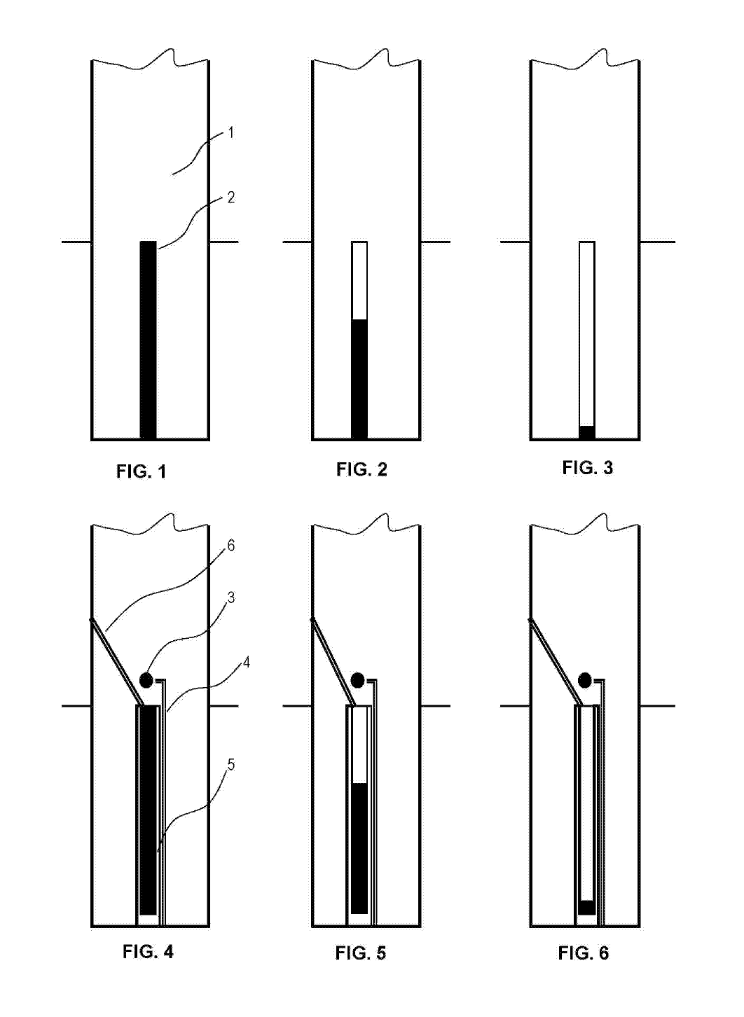

FIG. 1 shows a sectional view of a pole with a longitudinal tank in the pole axis, full of treatment product, according to the conventional technique. We distinguish the pole (1), and the tank (2).

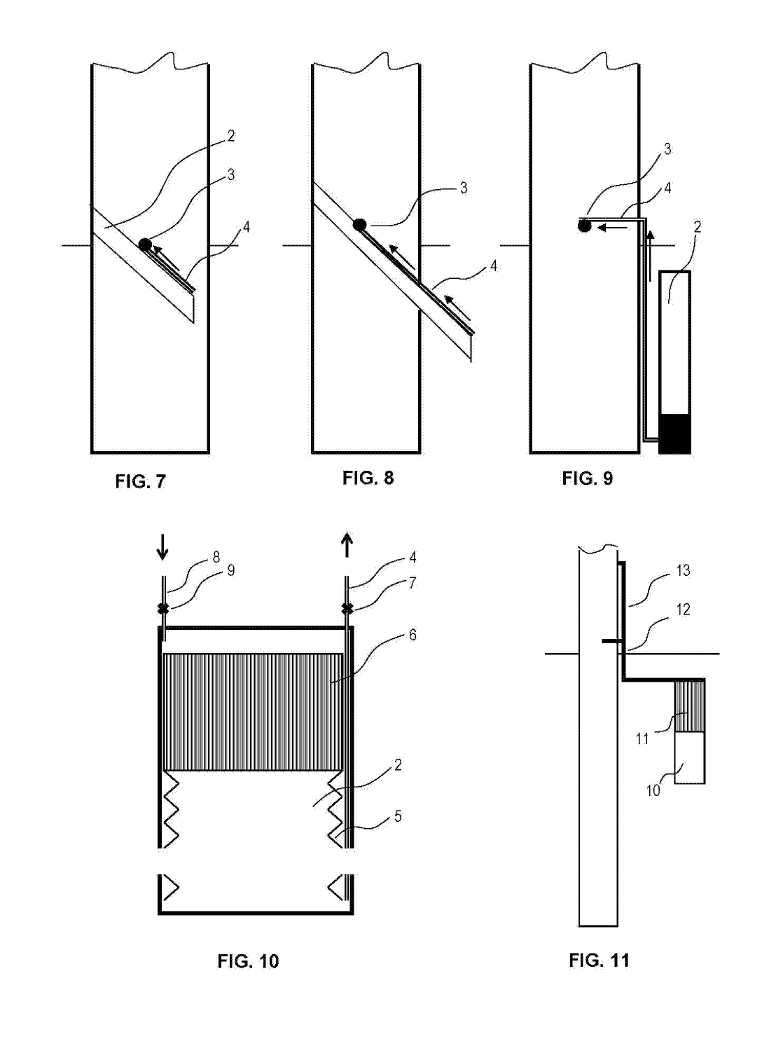

FIG. 2 shows a sectional view of the same pole, but with the tank half empty, according to the conventional technique.

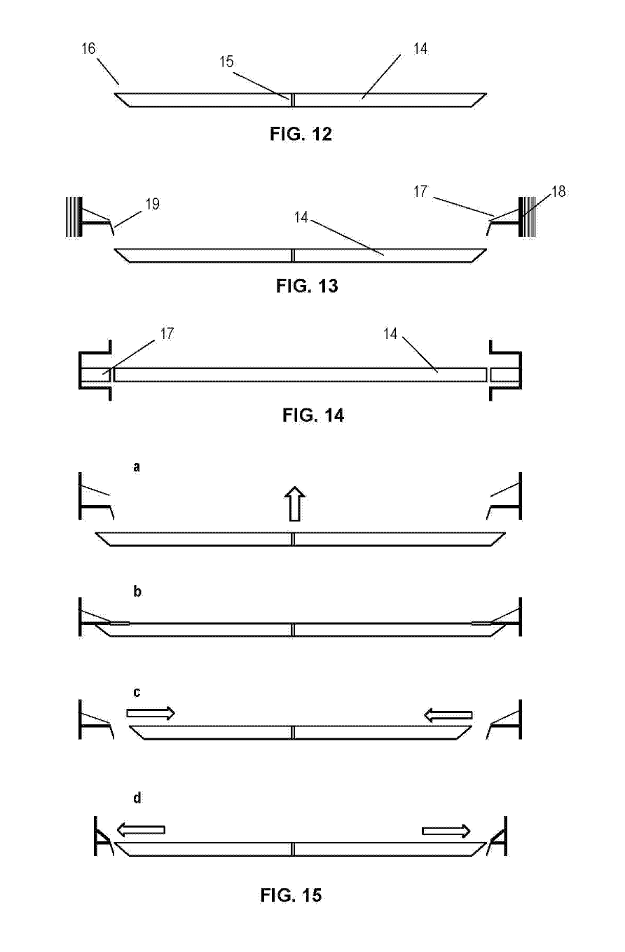

FIG. 3 shows a sectional view of the same pole, but with the tank almost empty, according to the conventional technique.

FIG. 4 shows a sectional view of a pole with a longitudinal tank in the pole axis as per this invention, with the tank still full of treatment product. There is only the point of penetration of the treatment product in the pole ground line area (3), the supply pipe (4), the tank cover which prevents the chemical from entering the pole by the entire surface of the cavity (5) and the air return pipe (6).

FIG. 5 also shows a sectional view of a pole with a longitudinal tank in the axis of the pole according to this invention, but with the treatment product in the half-consumed tank.

FIG. 6 also shows a sectional view of a pole with a longitudinal tank in the axis of the pole as per this invention, but with the treatment product in the tank almost completely consumed.

FIG. 7 shows a sectional view of a pole with an oblique tank in accordance with this invention. We distinguish the oblique tank (2), the point of penetration of the treatment product in the pole (3), and the supply pipe (4).

FIG. 8 shows a sectional view of a pole with an oblique tank according to this invention, which extends beyond the limits of the pole and enters the surrounding ground.

FIG. 9 shows a sectional view of a pole and a tank completely independent of the pole. The tank (2), the point of application to the ground line area of the treatment product (3) and the supply pipe (4) are distinguished.

FIG. 10 shows a sectional view of a tank where the treatment product rises to the point of application by pressure. The space occupied by the treatment product (2), the casing of the folded tank (5), the mass acting as a piston (6), the supply pipe (4), controlling the flow rate of the treatment product (7), the return air pipe (8), and the air return flow control valve (9).

FIG. 11 shows a sectional view of the relative position of the tank and the pole, in the case of using compressed air to pump the treatment product into the pole, placed below the treatment product.

The air under pressure (10), the treatment product (11), the supply pipe (12) and an example of a long opening valve (13) are distinguished.

FIG. 12 shows a sectional side view of the rod and locking clamps. We distinguish: The locking rod (14), the semi-articulation of the rod (15), and a specially shaped end of the rod (16).

FIG. 13 shows a sectional view of the rod and locking clamps.

There is a rod (14), a wedge (17), the embedment of the wedge at the bottom of the groove (18), and an orientation plate (19).

FIG. 14 shows a top view of the locking pin and grooves for the locking clamps. There is a locking rod (14) and a groove (20).

FIG. 15 shows different phases of the locking/unblocking operation of the rod by the bars.

FIG. 15a shows the rod rising towards the locking clamps, when the outlet valve of the treatment product is open.

FIG. 15b shows the wedge locked by the clamps, and the orientation plate pushed in horizontal position.

FIG. 15c shows the locking rod in the same position as before but in a retracted position at the lower temperature, the orientation plate released and returned to their original position.

FIG. 15d shows the locking rod in the same position as before, but expanding due to temperature rise, and moving over the bars.

### BEST MODE FOR CARRYING OUT THE INVENTION

The different ways of carrying out the invention differ in the choice of the technique or the combination of the techniques used to raise the treatment product in the supply pipe, on the one hand, as well as the control system or the combination of the control systems of said treatment product, on the other hand.

At the ground line area of a pole in use, a distribution network of the antiseptic solution, composed for example of 6 blind holes of small diameter, is drilled so as not to affect the mechanical stability of the pole, for example by 2 mm. These holes are then filled with sawdust. Two holes are horizontal and perpendicular to each other. The other four are oblique, regularly distributed on the circumference of the ground line area. All 6 holes intersect in the axis of the pole. The entrance of the holes is carefully plugged, except for one which is slightly larger and through which will pass the end of the supply pipe.

We take a cylindrical polyvinyl chloride (PVC) container, 25 cm in diameter and 60 cm high, for example, a volume of 29.438 dm³, which can easily be rounded to 30 dm³. The tank lid is provided with an orifice on which a supply line up to 15 cm above the ground level is applied, and then enters the distribution network of the antiseptic solution located at the ground line area.

At the bottom of the tank and up to a height of 30 cm, or half of its volume, is a watertight balloon conforming to the shape of given tank, filled with air under a pressure of 10,000 Pa or 0.1 bar.

The other half of the tank that remains above the balloon, 15 dm³, is occupied by a watertight balloon containing the antiseptic solution. The two volumes are separated by a rigid disk whose role can be likened to that of a piston in a cylinder.

The air under pressure in the flask will push the antiseptic solution into the supply pipe. Such a pressure of 10,000 Pa is capable of pumping the antiseptic solution to a height of 1 m. In reality it is necessary to subtract the pressure exerted by the height of the antiseptic solution, which is decreasing as the tank empties.

With respect to the pole, the tank is buried at a distance of about 50 cm towards the electrical or telephone line which includes the pole to be protected, so as not to affect the stability of the foundation of the said pole. In relation to the ground level, a space of 10 cm is left between the tank cover and the ground level, so that the bottom of the tank is at a depth of 70 cm.

As the antiseptic solution leaves the tank, the volume it occupies decreases; it is gradually replaced by the balloon containing air under pressure.

In the hypothesis, acceptable in our case, that we work at a constant temperature, this increase of the volume occupied by the balloon leads to a proportional reduction of the internal pressure, by virtue of the formula PV=K, P being the pressure of the air, V the volume occupied by the latter, and K a constant.

Thus, when the antiseptic solution is almost exhausted, the air balloon will occupy twice its initial volume, or 30 dm³ instead of 15 dm³, but at a pressure equal to half of its initial pressure, or 5000 Pa. Such pressure will be able to pump the last drop of the antiseptic solution to a height of 50 cm from the tank lid, i.e. 40 cm from the base of the pole. The exit of the supply pipe which is 15 cm from the ground level will always be fed with antiseptic solution.

The supply pipe passes through a regulating device comprising a thermally controlled valve which opens the passage only when the temperature is above 25° C. Thus, when the temperature is higher than 25° C. the device will pass a very small amount of the solution: of the order of one drop every 10 minutes. In order to minimize the consumption of the antiseptic solution, its passage through the valve is more like leakage of a liquid than a conventional fluid flow. In the choice of the opening threshold of the thermal valve, the pressure of the air in the balloon, and the size of the opening for the passage of the antiseptic solution, the objective is to have a flow rate of the order of 1 dm³ per year. Thus the 15 dm³ in the tank will protect the pole for 15 years before the reloading of the tank.

The antiseptic products that are most suitable for the permanent treatment of wood poles in use are borax products on the one hand, and table salt in solution when there is no risk of corrosion of accessories fixed on the pole, on the other hand. Both of these products have a relatively modest cost, and their impact on human or animal health and on the environment in general is very low.

It is for this reason that in the choice of the regulation parameters, we opt for a slight over-protection of the pole. This does not strike the cost of the operation, and remains safe for the environment.

The control valve is hosted in a small removable housing, so that it can be disassembled, checked and possibly changed after a number of years. It is possible to refill the tank in antiseptic solution at any time, through the supply pipe. At this time, the air balloon is compressed and returned to its original size where it again occupies a volume of 15 dm³ at a pressure of 10000 Pa. It should be noted that the working pressure of 10000 and 5000 Pa is sufficiently low so as not to cause air leakage likely to prevent the normal operation of the device, even for a long period of time.

### INDUSTRIAL APPLICABILITY

Despite the preservation treatment that takes place prior to their establishment, the poles are exposed to a high risk of ground line area attack mainly by the fungi responsible for wood rot.

Techniques for reprocessing existing poles exist and allow an extension of the life of the wooden poles.

This invention has a number of advantages over current techniques, including:
Resolves the main problem of the current techniques of ground line area treatment of poles in service (in use), which require removing the foundation of the pole to reach the ground line area and apply the treatment, breaking the pavements for poles installed in the agglomerations;
Performs an automatic treatment of the pole once a year from the tank buried in the ground next to the pole, for tens of years if desired;
opens up the possibility of using antiseptic products that are very inexpensive and have a negligible impact on the environment, such as borax and table salt, which cannot be used with current techniques due to their high sensitivity to rainwater.

What is claimed is:

1. A method for treatment of a ground line area of a wooden poles in contact with the ground, the method comprising:
forming an oblique or longitudinal cavity in the wooden poles;
hosting a watertight tank into or around the oblique or longitudinal cavity, wherein the watertight tank comprises a treatment product, the watertight tank having a supply or transfer pipe extending from a bottom portion of the watertight tank; and
routing the treatment product from the watertight tank via the supply or transfer pipe to come into contact with the wooden pole only along the ground line area, after having traveled through the supply or transfer pipe.

2. The method as claimed in claim 1, wherein, in the oblique cavity, hosting the watertight tank of the treatment product comprises:
hosting the watertight tank partially in the wooden pole and partially in soil surrounding the wooden pole along the ground line area.

3. The method as claimed in claim 1, wherein hosting the watertight tank, in the oblique cavity, comprises:
drilling the watertight tank of the treatment product directly and completely into soil surrounding the wooden pole along the ground line area, without any part of the watertight tank being in the wooden pole to host the watertight tank in a vicinity of the wooden pole.

4. The method as claimed in claim 2, further comprising:
forming, along the ground line area, small diameter holes to constitute a distribution network for the treatment product to be distributed.

5. The method as claimed in claim 4, wherein the distribution network comprises an absorbent material.

6. The method as claimed in claim 1, wherein routing the treatment product comprises:
overcoming gravity to ascend the treatment product to the ground line area, by means of electric pumping, at the pressure created by the weight of a body placed on the treatment product under liquid form, a gas under pressure, a mechanical spring, a capillary rise, or the combination thereof.

7. The method as claimed in claim 1, further comprising:
regulating a period and a output quantity of the treatment product and/or a return of air by one or more device involving a use of valves adapted to be controlled at least electrically, thermally, lightly.

8. The method as claimed in claim 1, further comprising:
routing the treatment product partially or totally by using of a capillarity of an absorbent body placed along a path of the treatment product to the ground line area, wherein performance of the capillarity combines an action of a highly absorbent flexible absorbent material, with a rigid body, to constitute a sort of rigid ladder for the treatment product to be transported to the ground line area.

9. The method as claimed in claim 1, further comprising:
installing the watertight tank having the treatment product at a top of the wooden pole to benefit from the action of gravity in conveying the treatment product to at the ground line area or other point of application at the pole.

10. The method as claimed in claim 1, further comprising
pushing the treatment product into the supply or transfer pipe via a piston and a blocking rod integral with the piston, wherein the rod comprises locking clamps that enables a variation in a length of the rod with the variation of temperature, such that the rod is locked against locking clamps above a certain temperature, and the rod is released from the locking clamps below a certain temperature, thereby allowing the continuation of the pumping from the treatment product to the wooden pole, when an outlet valve of supply or transfer pipe carrying the treatment product is open.

11. The method as claimed in claim 10, wherein the locking clamps of the piston or a part thereof are retractable.

12. The method as claimed in claim 10, wherein the rod and/or the locking clamps comprises of a hollow body filled with gas to expand and shrink as a function of temperature, possibly using a slight depression to result in intense evaporation, or via boiling, likely to cause sufficient elongation of the rod.

13. The method as claimed in claim 10 further comprising:
one or more constructive arrangements firstly to enable the watertight tank to be refilled with the treatment product without the blocking clamps blocking the rod, and
secondly to prevent the rod blocking is not blocked by the clamps when, after retracting due to the decrease of the temperature, rod expands again with the increase of the temperature, wherein the one or more of the constructive arrangements comprises:
a semi-rigid articulation of the locking rod allowing the rod to configure a V-shape;
a flexible locking rod to bend slightly in the opposite direction to the pumping force;
a bar and a flexible or articulated blade placed at an end of the bars; and
tapered end design of bar and rod to orient the blocking rod in a desired direction.
